(19) United States
(12) Patent Application Publication
(10) Pub. No.: US 2016/0353675 A1
(43) Pub. Date: Dec. 8, 2016

(54) ADJUSTABLE PLANT HOLDER

(71) Applicant: Althemon O'Meally, New York, NY (US)

(72) Inventor: Althemon O'Meally, New York, NY (US)

(21) Appl. No.: 15/169,364

(22) Filed: May 31, 2016

Related U.S. Application Data
(60) Provisional application No. 62/146,249, filed on Jun. 3, 2015.

(51) Int. Cl. A01G 9/12

(52) U.S. Cl. CPC A01G 9/12

(57) ABSTRACT

An adjustable plant holder formed by a telescopic pole and two fixing bases is disclosed. The telescopic pole is formed by an upper pole and lower pole sleeved within each other. Each end of the individual telescopic poles is connected to one of the fixing bases respectively. Each of the poles is provided with regularly arranged openings. The height of the telescopic pole can be adjusted by aligning openings of the inner pole with openings of the outer pole, and a holder for at least one plant provided.

### CROSS REFERENCE TO RELATED APPLICATION

The present application claims priority of provisional application 62/146,249, filed Jun. 3, 2015. The provisional application is incorporated herein in its entirety.

### TECHNICAL FIELD

The present invention relates to a plant holder for both indoor and outdoor use applications. More particularly, it relates to a plant holder having an adjustable height and customizable configurations.

### BACKGROUND OF THE INVENTION

There is available a plurality of different designs for plant holders to use in displaying plants. As planta may be quite heavy, in general, a plant holding and displaying device typically includes multiple shelving units arranged either horizontally or vertically for holding or displaying different sizes of plants. Even in those designs where a shelving unit is not included, a plant holder device is bolted down to a mounting surface, and is not easily removed.

In addition, the currently existing plant holders are typically very bulky, not only taking up a lot of space but also are not very attractive. Most importantly, the current plant holders do not easily allow a gardener or other individual to change the arrangement of plants so as to provide different themes or presentations, for example with changing seasons and for different occasions, for example holidays.

In today's world, wherein space, time and design are important, a versatile, easy to use plant holder is needed.

### SUMMARY OF THE INVENTION

The present invention provides a plant holder, which not only saves space by having an adjustable height, but also incentivizes a gardener to configure the plant holder to provide different arrangements as indicated by season, occasion, location, etc. from time to time and in particular, arrangements which can be easily changed to reflect the same.

A primary object of the present invention is to provide a plant holder constructed so that it can provide customizable configurations tailored to each customers taste and need.

Another object of the present invention is to provide a sturdy support for an individual plant or plants weighing up to 7 and more pounds.

Another object of the present invention is to provide a plant holder having an attractive appearance which contributes to the appearance of the display of one or more plants.

Another object of the present invention is a plant holder which is easy to use and easy to assemble to provide for the display of plants.

The present invention provides an improved structural design for a plant holder, which comprises a telescopic pole comprised of an inner pole and outer pole, wherein the inner pole is sleeved inside an outer pole, each having a plurality of predetermined openings. The inner pole and outer pole are arranged so that at least one of the openings on the inner pole and one of the openings of the outer pole can be aligned and which is capable of sustaining a supporting device for a plant which weighs up to about 7 lbs. Each of the telescopic poles is further connected to a fixing base or pivotal base configured to allow each pole to be inserted, mounted or held by a mounting surface.

### BRIEF DESCRIPTION OF THE DRAWINGS

The invention will be readily understood by the following detailed description in conjunction with the accompanying drawings, wherein like reference numerals designate like structural elements, and in which:

FIG. 1a schematically illustrates the telescopic pole of the present invention, wherein the telescopic pole is in its extended state;

FIG. 1b schematically illustrates the telescopic pole of the present invention, wherein the telescopic pole is in its not in fully extended state;

FIG. 2a schematically illustrates the telescopic pole of the present invention, when it is extended and connected to two opposing surfaces;

FIG. 2b schematically illustrates the telescopic pole of the present invention, when it is mounted to one surface;

FIG. 3 schematically illustrates one example of pivotal base attachment;

FIG. 4 schematically illustrates another example of pivotal bottom attachment;

FIG. 5 schematically illustrates another example of pivotal bottom attachment;

FIG. 6 schematically illustrates another example of pivotal bottom attachment;

FIG. 7 schematically illustrates one example of pivotal top attachment;

FIG. 8 schematically illustrates another example of pivotal top attachment;

FIG. 9 schematically illustrates another example of pivotal top attachment;

FIG. 10 schematically illustrates another example of pivotal top attachment;

FIG. 11 schematically illustrates one example of pivotal left side attachment;

FIG. 12 schematically illustrates another example of pivotal side attachment;

FIG. 13 schematically illustrates another example of a pivotal right side attachment;

FIG. 14 schematically illustrates one example of a telescopic plant holder and how it is arranged in a target area, in accordance with aspects of the present invention;

FIG. 15 schematically illustrates another example of a telescopic plant holder and its arrangement in another target area, in accordance with aspects of the present invention;

FIG. 16 schematically illustrates another example of a telescopic plant holder and its arrangement in another target area, in accordance with aspects of the present invention;

FIG. 17 schematically illustrates one example of a pot holding element;

FIG. 18 schematically illustrates another example of a pot holding element;

FIG. 19a schematically illustrates another example of a pot holding element;

FIG. 19b schematically illustrates an alternate embodiment of the pot holding element of FIG. 19a;

FIGS. 20 and 21 are examples of lower pole with a bottom attachments;

FIGS. 22-27 are illustrations of basic individual parts that can be used to assemble into a plant holder of the present invention;

FIGS. 28-37 are illustrative examples of advanced jointed parts and connectors, which can be made from two or more individual basic parts, to help to assemble the system into a plant holder of the present invention;

FIGS. 38-43 are illustrative examples how the plant holder is secured to a surface on the bottom;

FIGS. 44-46 offers examples of pot holding elements and how it is placed on the top of the plant holder;

FIG. 47 is an alternative top attachment of the plant holder;

FIG. 48 is an illustration of a side attachment of the plant holder;

FIGS. 49-50 are illustrative examples of brick attachments as side attachments of the plant holder;

FIGS. 51 and 52 show alternative side attachments of the present invention;

FIG. 53 shows parts of the plant holder assembly other than pot holding elements.

### DETAILED DESCRIPTION OF EXAMPLE EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents that can be included within the spirit and scope of the described embodiments as defined by the appended claims.

The elements in the figures are

101 upper pole

103 lower pole

105 a hole on the upper pole

107 a hole on the lower pole

202 an example of a pivotal bottom attachment

203 another example of a bottom attachment as a foot receiver

204 another example of a pivotal bottom attachment

206 another example of a pivotal bottom attachment

208 another example of a pivotal bottom attachment

302 one example of a pivotal top attachment

304 another example of a pivotal top attachment

306 another example of a pivotal top attachment

308 another example of a pivotal top attachment

402 one example of a pivotal left side attachment

404 another example of a pivotal side attachment

406 another example of a pivotal right side attachment

602 one example of a pot holding element

604 another example of a pot holding element

606 another example of a pot holding element

608 top supporting ring member

609 bottom supporting member

611 top gripping member

612 bottom gripping member

650 another example of a pot holding element

652 bottom supporting member

654 bottom mountng hole

656 top mounting hole

658 top supporting member

702 an example of a receptacle

704 another example of a receptacle

706 another example of a receptacle

801 a first L shaped bar

802 a second L shaped bar

804 flat bar

803 a third L shaped bar

805 slide over sleeve

807 double screw receiver

808 lower frame holding bracket

A plant holder comprising a telescopic pole is disclosed herein. The plant holder can be used for both indoors or outdoors. The telescopic pole comprises an inner pole arranged inside an outer pole for adjusting the total height of the telescopic pole. Each of the parts of the telescopic pole is connected to a pivotal base for mounting the same in an upright position. The telescopic pole is secured between or onto two mounting surfaces through a pivotal base. Each telescopic pole has predetermined regularly arranged openings.

### Pole

In the scope of the present invention, a pole is intended to mean a tube or a rod that provides basic engineering structure for the plant holder. The telescopic pole in the present invention has a horizontal cross section substantially round or slightly oval, so that an inner pole can be inserted inside the outer pole easily at any angle. The horizontal cross section means the cross section is perpendicular or substantially perpendicular to a length of the telescope pole. The pole can be either straight or have a slight curve. In one embodiment, the telescopic pole is substantially straight. In another embodiment, the telescopic pole after the inner pole is fully extended out of the outer pole, the telescope pole has a bending angle. In still another example, both the inner pole and outer pole have a bending angle or curvature, so that the two poles can be adapted to surfaces arranged either in parallel or having an angle.

The structure of telescoping pole can be made of any material as long as when the plant holder is assembled, it can be used to hold a plant having a weight of about 7 lb. or less. The telescopic pole can be made of a plastic material, or a metal material. It can be further coated with weather protective coatings to make it more adaptable for either indoor or outdoor use.

The telescopic pole comprises an inner pole and an outer pole. The inner pole is inserted in to the outer pole through a radial opening. In one example, the inner pole is an upper pole and the outer pole is a bottom pole. In another example, the inner pole is a bottom pole.

### Length is Adjustable

The plant holder of the present invention is intended for either outdoor or indoor use for shorter and longer periods (weeks, months, etc.), according to the season that is associated with the plant that is being displayed. In order for the plant holder to be adaptable to different environments and be fit for multiple locations, the length of the telescopic pole of the plant holder is adjustable. In some examples, the two ends of the telescopic pole are respectively connected to a fixing base and the angle between the telescopic pole and the fixing base cannot be adjusted.

### Hole

The plant holder in the present invention comprises a telescopic pole, including an inner pole and outer pole. Both the inner pole and outer pole have regularly arranged openings along their lengths. The openings on the inner pole and outer pole are aligned by adjustment so that an outer pole opening overlies an inner pole opening. The aligned openings can then accommodate a supporting member for a plant. The openings on the poles can be of any shape. In one example, the openings are substantially round or oval shaped.

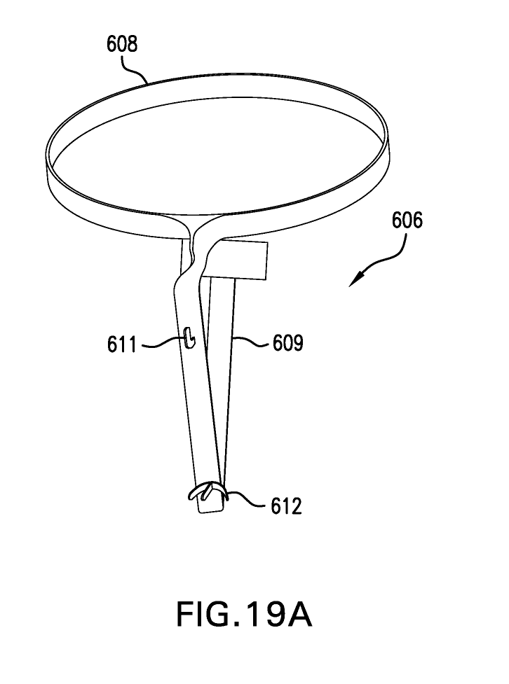

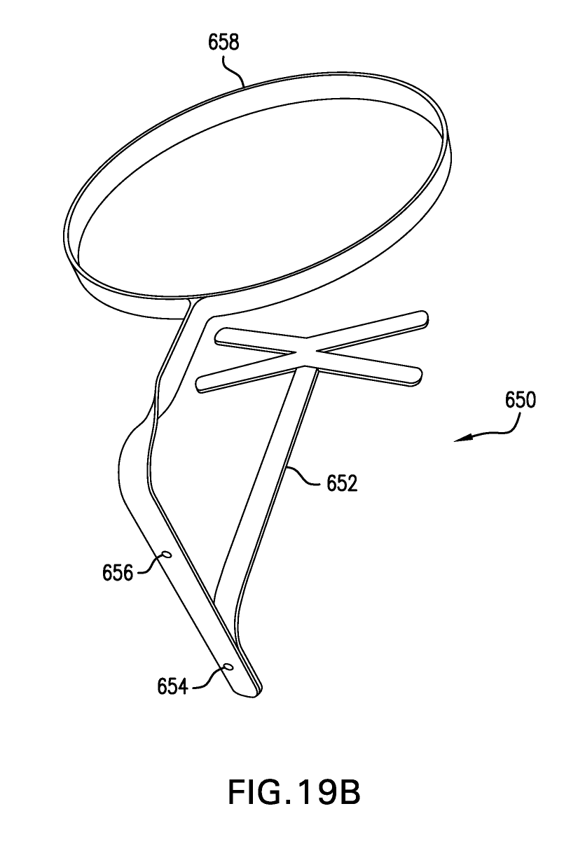

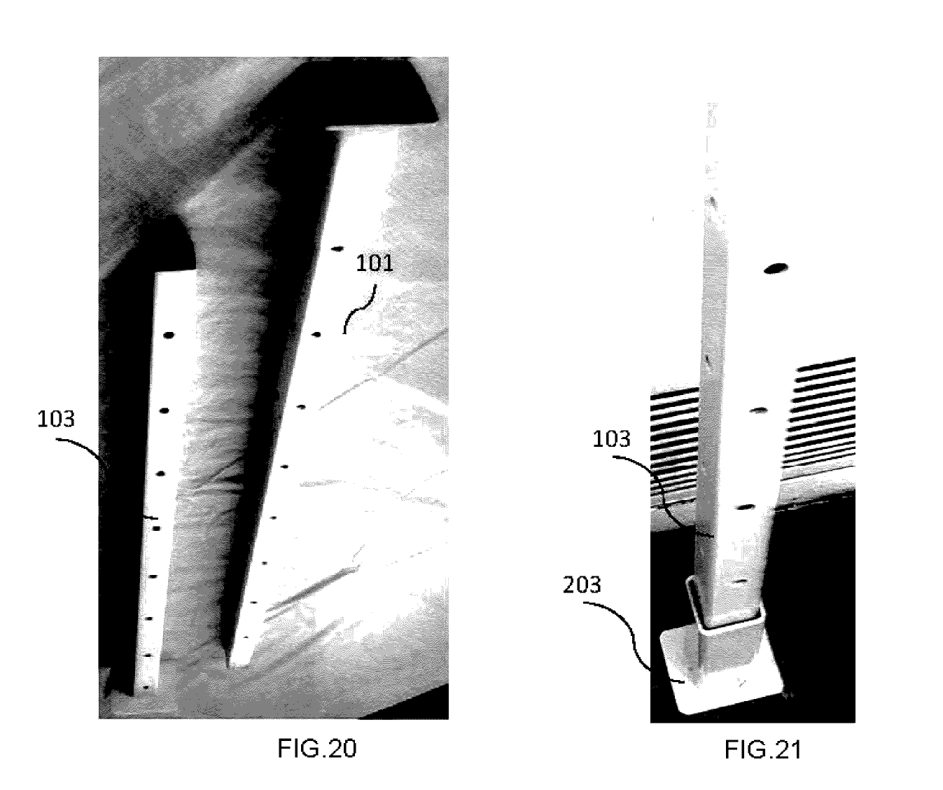

In accordance with the aspects of the present invention, the openings are regularly arranged in a pattern. In one example, the pattern includes the openings which are arranged so as to be equidistant with neighboring openings. In another example, the pattern includes openings which are grouped in pairs, and the pairs are organized at equal distances from pair to pair. However the two openings within a pair have a shorter distance than the two neighboring openings. Referring to FIG. 19a, when the telescopic pole is assembled so as to be a supporting device for a plant, a first member of the openings in the pair on the side of the telescopic pole is configured to accommodate a top supporting member in the supporting device and the second member of the openings in the pair on the side of telescopic pole is configured to accommodate a bottom supporting member.

In another aspect of the present invention, in one embodiment, the sizes of the openings are same from top to bottom in both the inner and outer telescopic poles. In another example, the openings on the side of the telescopic pole have varying diameters or widths so as to accommodate different sizes of supporting devices. Normally, the heavier the plant is, the stronger the support member. Typically, a stronger support member is either made of a material having more tensile strength or the same material but having stronger structure, which sometimes requires a bigger opening in the pole to accommodate the heavier plant(s). In another example, the openings are arranged to have small to big sizes progressively from top to bottom.

### Pivotal Base

The plant holder in accordance with the aspects of the present invention is secured to the target location through one or more pivotal bases. The pivotal bases in the present invention designate structural components that are capable of providing a fundamental and essential structural support to secure the telescopic pole to a mounting surface. A pivotal base includes, but is not limited to, a top base, attaching a upper telescopic pole to a surface located above the upper telescopic pole, a bottom base attaches a bottom telescopic pole to the a surface situation below the telescopic pole, and a side base attaching a side along the length of either an upper telescopic pole or lower telescopic pole, or both. The word “base” in the present invention, means base support, or fundamental support, “Pivotal base” does not limit the location of the base to must be underneath the telescopic pole.

Relationship with the Base

A plant holder comprising a telescopic pole whose length is adjustable is disclosed. The telescopic pole can be attached to the mounting surface using a pivotal base. In one example, such a base in not exposed above the mounting surface for aesthetic reasons, as shown in FIGS. 2a and 2b. In another example, the fixing or pivotal base is not exposed when the plant holder is used outdoors so that the base part cannot easily become stained or rusted due to exposure to the environment.

In another example, the pivotal base is exposed and has an elegant design to contribute to the attractive display of the plant holder. The base is coated with environmental protective coatings to extend its useful lifetime.

In another aspect of the present invention, in one example, the telescopic pole of the plant holder is assembled to an upper or bottom base vertically, whereas the telescopic pole of the plant holder is assembled to a side base horizontally. Thus the angle between the telescopic pole and the fixing base is limited and fixed. Preferably, the plant holder is set up between two mounting surfaces; the two mounting surfaces are substantially parallel to each other, as for example, the ground and a ceiling.

Optionally, the plant holder of the present invention can be adapted for use in an environment where there is a slight angle between the two mounting surfaces. In one embodiment, two ends of the telescopic pole are connected to the two fixing bases respectively. The length of the telescopic pole between the two fixing bases can be adjusted and changed. The two fixing bases are respectively mounted on each of two surfaces with an angle there between. The angle between each of two ends of the telescopic rod and each of the two fixing bases are adjustable according to the angle present between the two mounting surfaces.

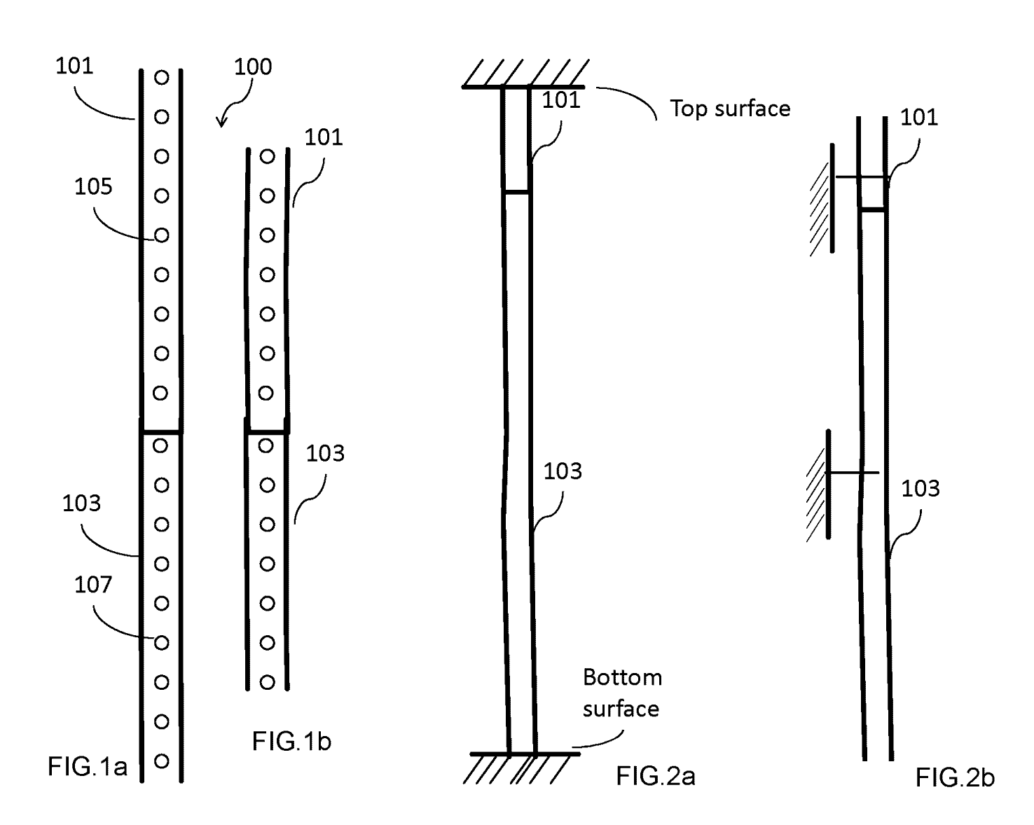

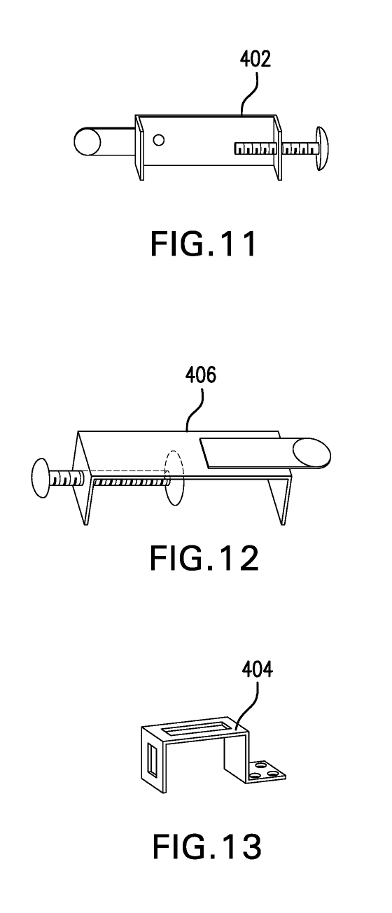

FIGS. 1a-19b are detailed examples of embodiments of the present invention. The plant holder, in accordance with the aspects of the present invention, that is formed by a telescopic pole and two fixing bases for securing the telescopic pole to mounting surfaces and is easily mounted on two parallel mounting surfaces or two mounting surfaces having an angle there between. The telescopic pole has an inner pole and outer pole, each having regularly arranged openings designed so that the height of the telescopic pole can be adjusted and the openings aligned by adjustment so that an outer pole opening over lies an inner pole opening, the overlying openings can accommodate a supporting device for a plant. The plant holder is assembled with two fixing bases so that a plurality of plants weighing about seven lbs. or less can be supported.

Referring to FIGS. 1a-1b, The plant holder is comprised of a telescopic rod 100, which is composed of an inner pole 101 and an outer pole 103, sleeved within each other while the two ends of the telescopic pole 100 are connected to the two fixing bases 200 (not shown) respectively. Referring to FIG. 2, the relative length of inner pole and outer pole can be adjusted for different purposes. The inner pole can be an upper pole and the outer pole can be a bottom pole as shown for safety and stability considerations. But in some examples, other arrangements might be more preferred. FIG. 2 further shows, the pivotal base of the plant holder can be covered by the mounting surfaces.

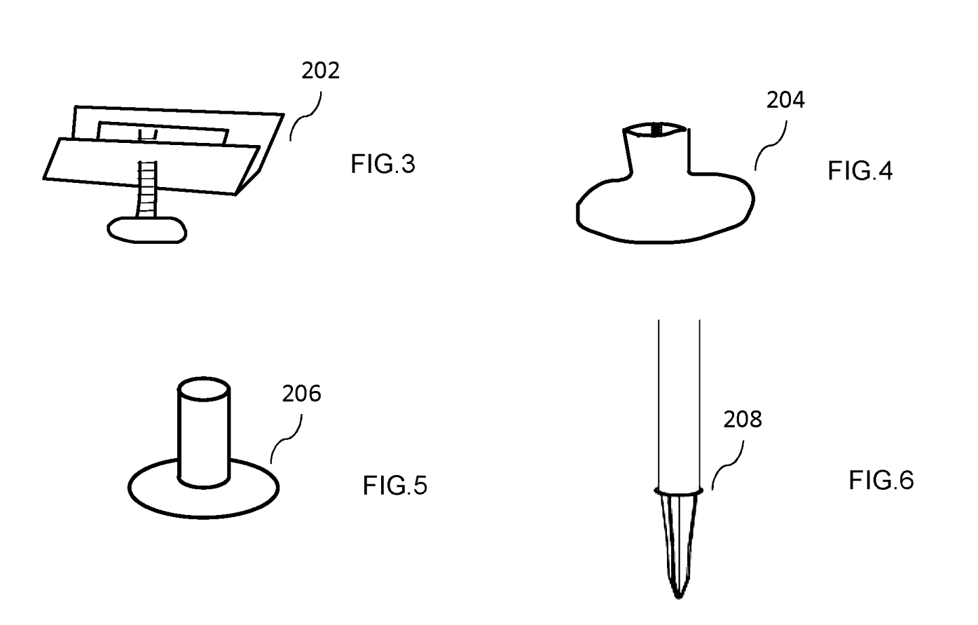

FIGS. 3-6 are examples of bottom pivotal bases in accordance with the aspects of the present invention. FIG. 6 shows a radial insertion hole 208, which can be inserted to a mounting surface, for example, sand or soil ground, directly. FIG. 4 illustrates an example of a mounting base 204, which wider end is secured to the mounting face, and its narrow end receives the bottom end of the telescopic pole. For example the wide end has a suction cup like means and the narrow end has a screw. The bottom end of the telescopic pole can simply be hand screwed onto the pivotal base without any additional tools. FIG. 5 shows a sturdy weighted base 206, a wide end of the base can be supported on a flat mounting surface, for example a floor or a rug, and the narrow end of the base 206 can be a solid or hollow cylinder configured to insert or receive the bottom end of the telescopic pole by a male and female joint.

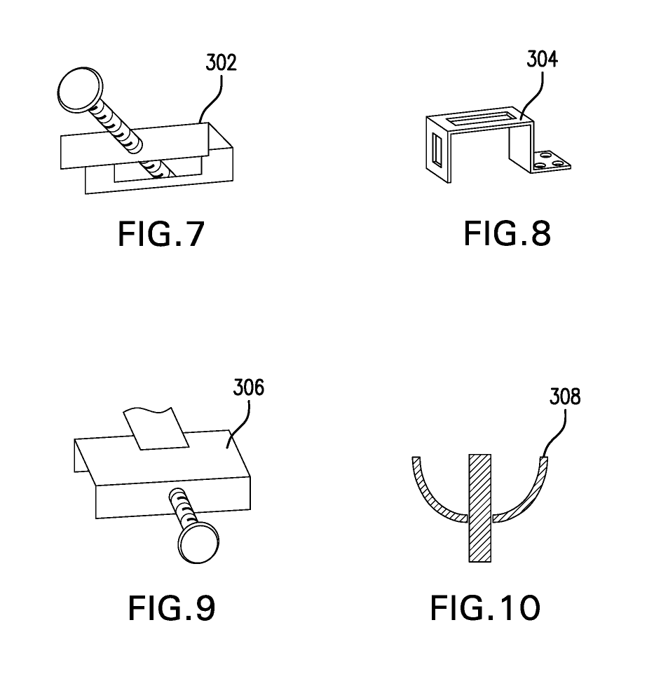

FIGS. 7-10 illustrate examples of pivotal bases that can be used on the top of the telescopic pole. Some of the top bases include a flange-like structure, for example 302, 304 and 306. Most of the top bases are designed so that no additional hardware has to be used to assemble the telescopic pole with the top base. For example top bases 302 and 306 in FIGS. 6 and 8 include using a hand screw or thumbscrew for fastening. Some top bases are designed to enhance the display value for the plant stand, for example top base 308 in FIG. 9.

FIGS. 10-12 illustrate examples of pivotal bases 402, 404 and 406 that can be used on the side of the telescopic pole. The side pivotal bases can be used independently or in addition to the top and bottom pivotal bases.

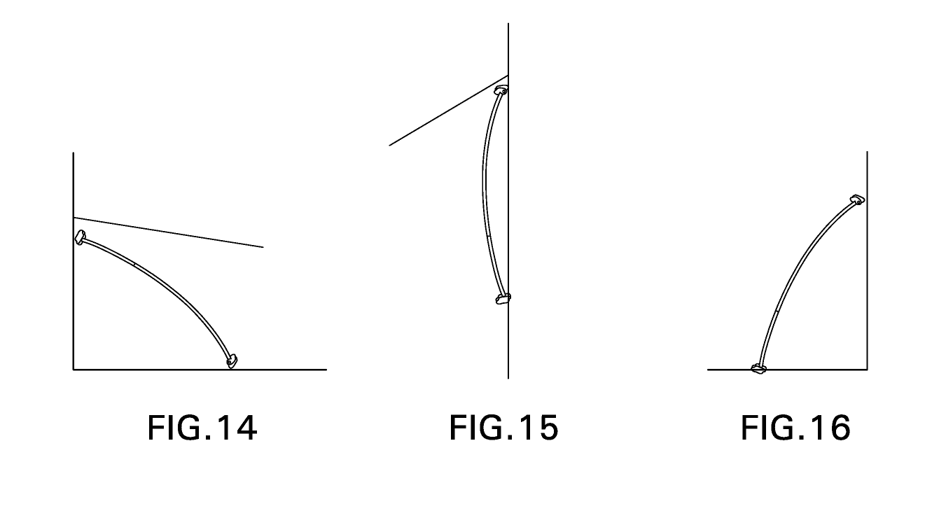

FIGS. 2a and 2b illustrate the plant holder comprising a telescopic pole, having an inner pole and outer pole wherein when the inner pole and outer pole assembled together can be adapted for mounting between two parallel mounting surfaces. FIGS. 14 and FIG. 16 show two alternative embodiments of FIG. 2, wherein the plant holder comprises a telescopic pole, when the telescopic pole is assembled, it can be fitted to two mounting surfaces that are not parallel to each other. Further, FIG. 2a shows that the plant holder in the present invention comprises a telescopic pole, having an inner pole and outer pole wherein when the inner pole and outer pole are assembled together it can be mounted to a surface through the side attachment. In one example, the side-mounting surface is substantially straight and the telescopic pole is also substantially straight. In another example, the side mounting surface is substantially straight whereas the telescopic pole after it is assembled is slightly bent in order to balance a weight distribution of different plants, making the entire plant holder more stable. At the same time, the overall appearance of the plant holder is thereby improved.

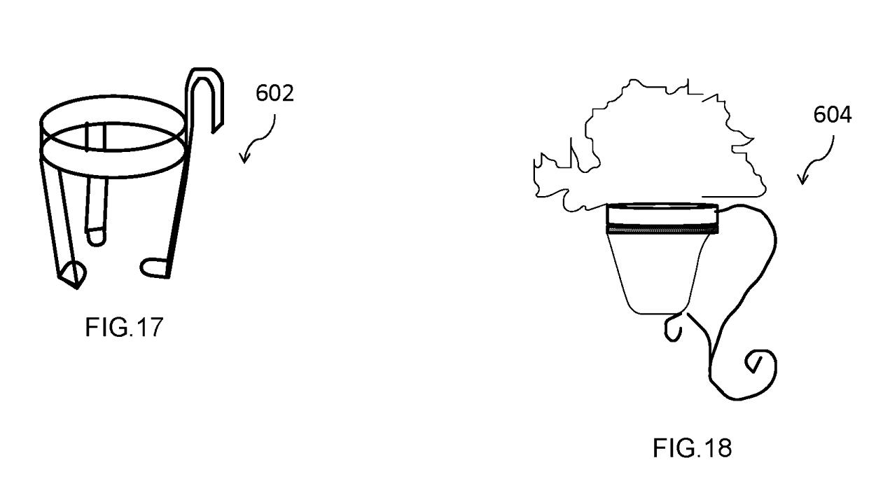

The plant holder, in accordance with the aspects of the present invention, further comprising a supporting device for a plant, in other words, pot holding elements 602, 604 and 606. Examples of supporting devices are schematically illustrated in FIGS. 17-19b. The supporting device 606 shows basic structures of the supporting device, including a top supporting member 608, a bottom supporting member 609 and a top side gripping element 611 and a bottom gripping element 612, wherein the top supporting element is ring-shaped, holding the periphery of the pot and the bottom supporting element is configured for providing support to either the corners or the entire bottom surface of the plant pot. In an alternate embodiment, supporting device 650 includes a top supporting member 658, a bottom supporting member 652 having an X-shaped end, a top mounting hole 656 and a bottom mounting hole 654, wherein hooks, pins, screws and other similar mounting devices can be mounted or attached to mounting holes 654, 656. The supporting device 602 uses only a top gripping element 611 and the supporting device 604 uses only a bottom gripping element 612.

In one preferred embodiment, the upper pole 101 and lower pole 103 are straight poles. Further, the upper pole 101 and lower pole 103 are squared poles wherein the cross section of each pole with respect to the longitude direction of the pole is square shaped. On each pole there are the openings which are regularly arranged in a pattern. In one example, the openings are round, and each is about 3 inches of the nearest neighboring opening.

A bottom end of the lower straight pole can be placed in a foot receiver 203. The foot receiver is a preferred embodiment among all the bottom attachments. The foot receiver is 3 inches in height, having 1.25-inch wide square bottom attachment. Correspondingly, the width of the straight pole entered into the foot receiver is about 1 inch.

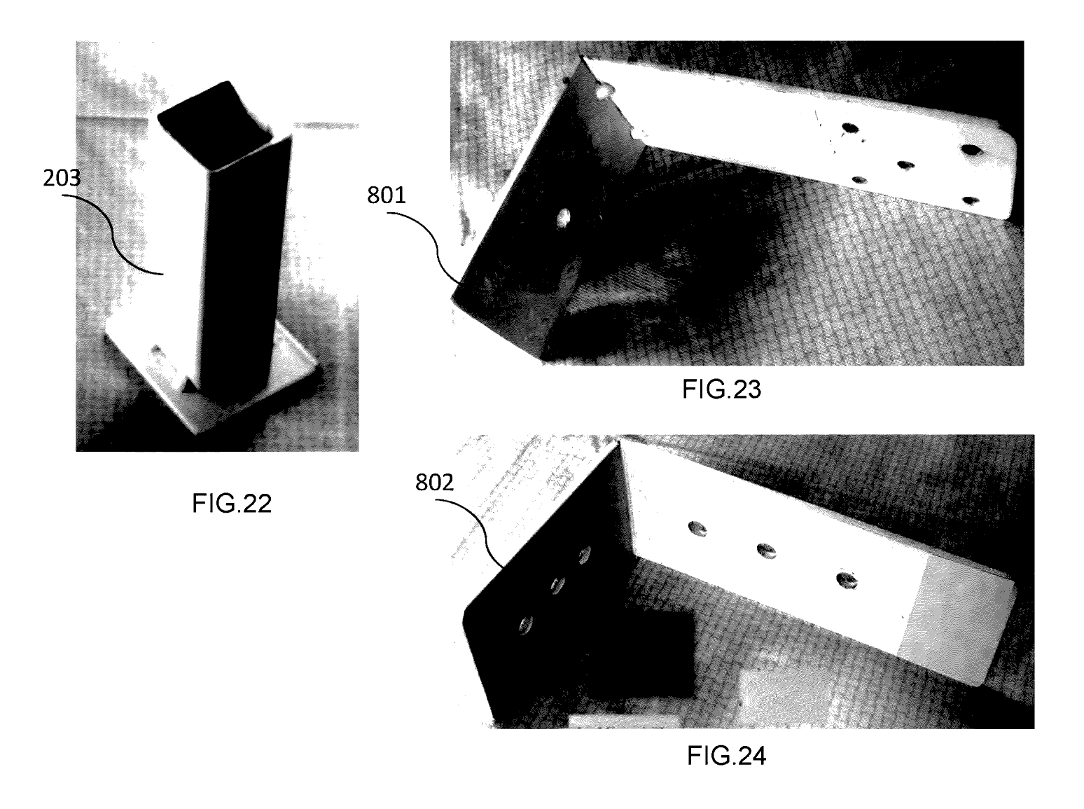

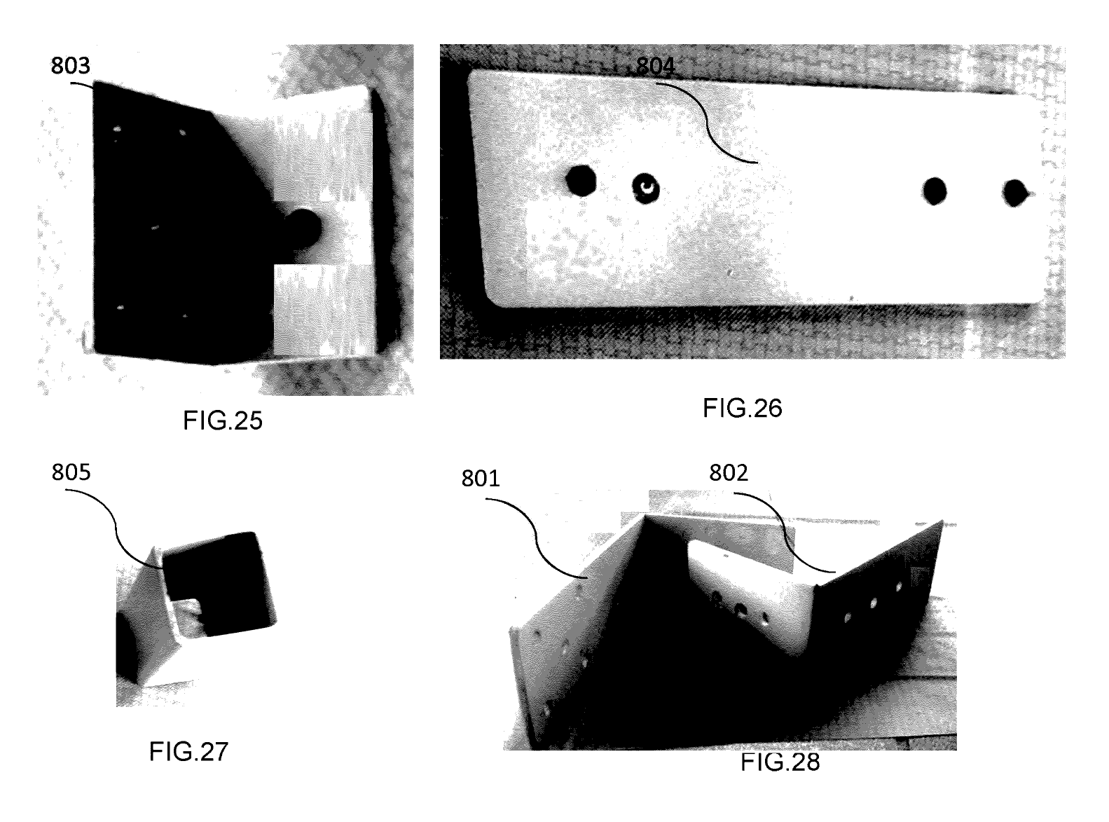

FIGS. 22-27 are illustrations of basic individual parts that can be used to assemble into a plant holder.

The first L shaped bar 801 measures 5 inch long on one arm and 3 inches on the other arm. The long side has 5 holes, and the shorter side has one hole.

The second L shaped bar 802, both arms have three through holes, The longer arm is 3.5 inch and the shorter arm is 3 inch.

The third L shaped bar 803, has both arms at equivalent length at about 2 inches long. On one side five holes are disposed in order for screws to pass through to be attached to side window frames. The single hole on the other side is designed to lock onto a flat bar 804.

The flat bar 804 is shown in FIG. 26. The flat bar is about 6 inches long and 2 inches wide, having four holes equally distributed across the center of the flat bar toward the ends of the flat bar.

FIG. 27 shows a slide over sleeve, which can be used to slide over the bottom end of the lower pole. Because sometime a screw may be used to attach the bottom end of the lower pole to a window frame, a sleeve cover 805 serves as a protective and aesthetic cover. In one example, the sleeve cover 805 is 1.25 inches in width and 3 inches tall.

FIGS. 28-37 are illustrative examples of advanced jointed parts and connectors, which can be made from two or more individual basic parts, to help to assemble the system into a plant holder.

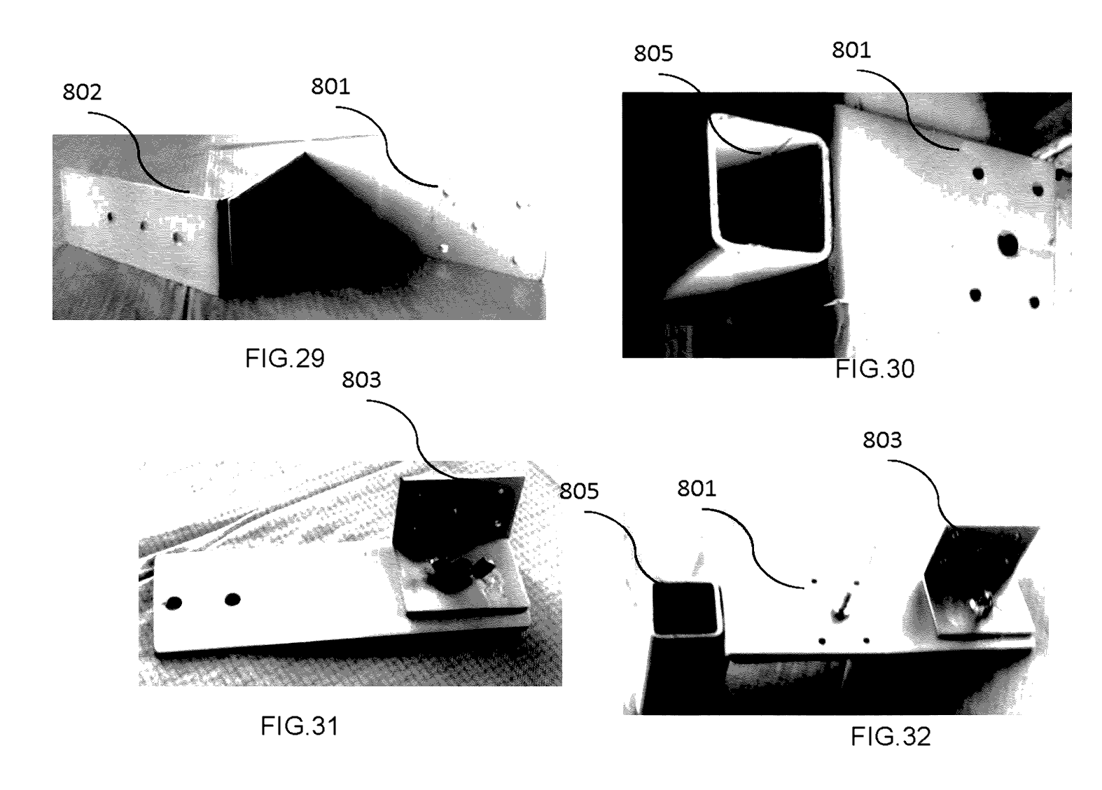

FIG. 28 shows that the first L shaped bar 801 and the second L shaped bar 802 can overlay with each other having only one arm overlap, then the two L shaped bars can be secured through one hole of 801 on the shorter arm and one of the three holes of 802 on the shorter arm. After two L shaped bars are lock to each other through a screw, as is shown in FIG. 29. FIG. 30 shows that the third L shaped bar and sleeve cover can be welded together, and be further used as help the upper or lower pole of the plant holder to be secured to a surface as a side attachment.

FIG. 31 shows the third L shaped bar 803 can be used to join a flat bar 804 to be used as a corner bracket for the plant holder. In one example, the flat bar 804 is 6 inches long.

FIG. 32 shows the binary jointed parts in FIGS. 30 and 31 can be further connected to form a lower frame holding bracket.

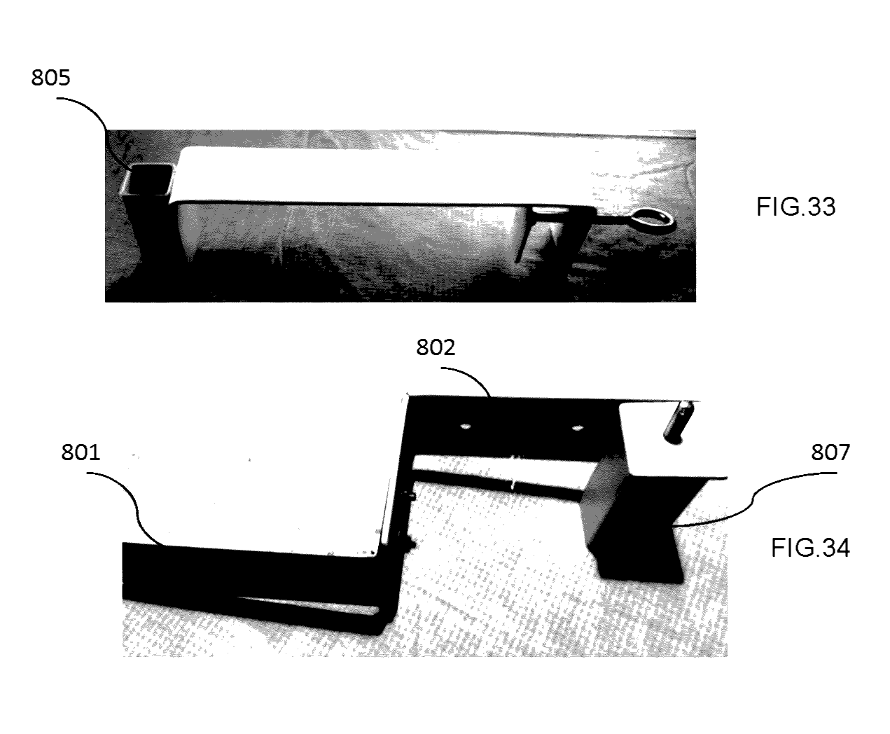

FIG. 33 shows a brick stabilizer bracket, which is 12.5 inches long, and 2 inch wide. The brick stabilizer bracket carries an opening of 10.5 inches with a 1.25 inch sleeve bar for an inch pole to go through and prevent falling.

FIG. 34 shows two L shaped bar with a double screw receiver 807. The three holes on both L shaped bars can be used for position adjustment.

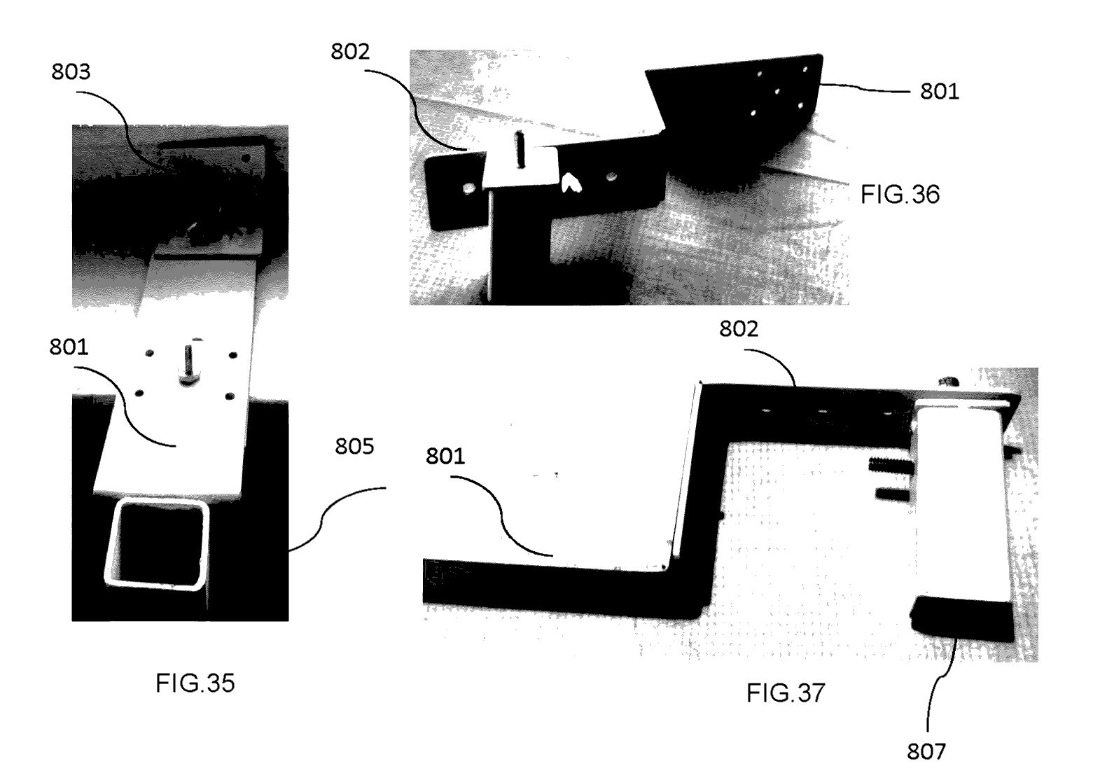

FIG. 35 shows the third L shaped bar, the flat bar, a lower frame holding bracket made from a sleeve cover and the first L shaped bar which can be used to hold the plant holder on the side of a window.

FIG. 36 shows two L shaped bars and double screw receiver 807 locked in position to be installed on the side of a window frame.

FIG. 37 shows two L shaped bars and the double screw receiver are locked in a position to allow the plant holder to attach to an upper window frame.

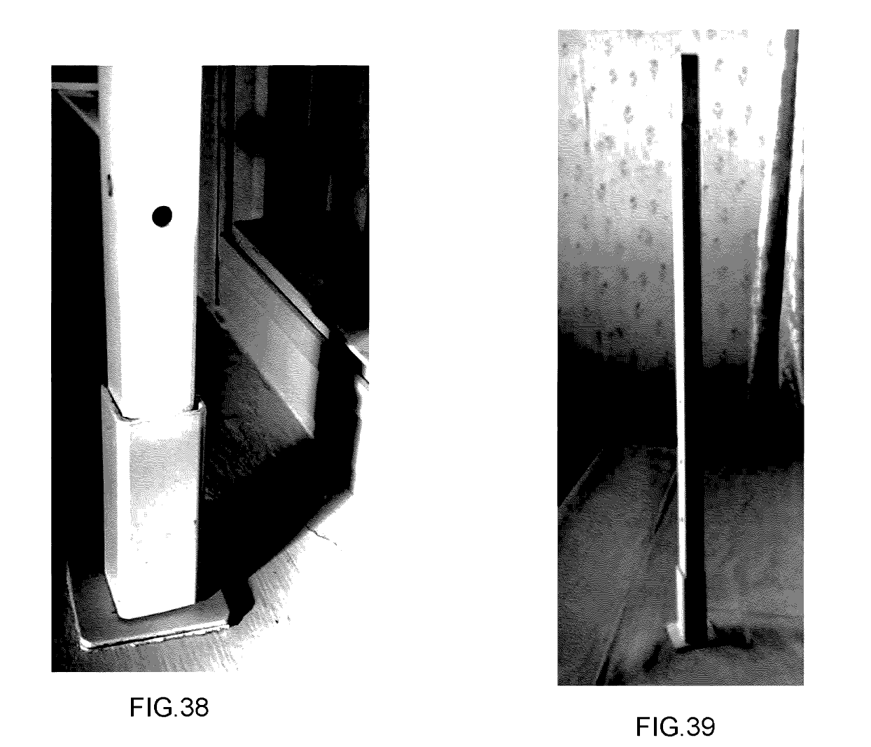

FIGS. 38 and 39 shows that in one example, the bottom of the plant holder can be located on a window surface by simply placing the lower pole in to a bottom attachment. The surface can be either a surface next to the window or on a table.

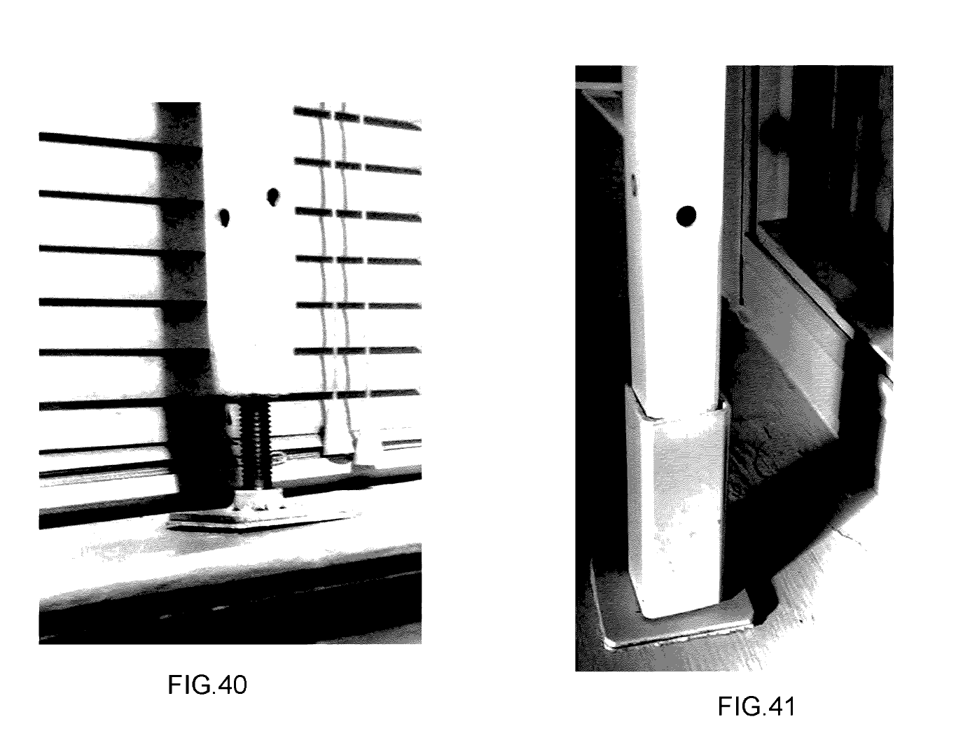

FIG. 40 shows that the bottom end of the lower pole can be fixed with a screw in the bottom base support, without the sleeve in cover, the screw in fixture is exposed. To make it more esthetically appealing, a sleeve cover can be used as shown in FIG. 41.

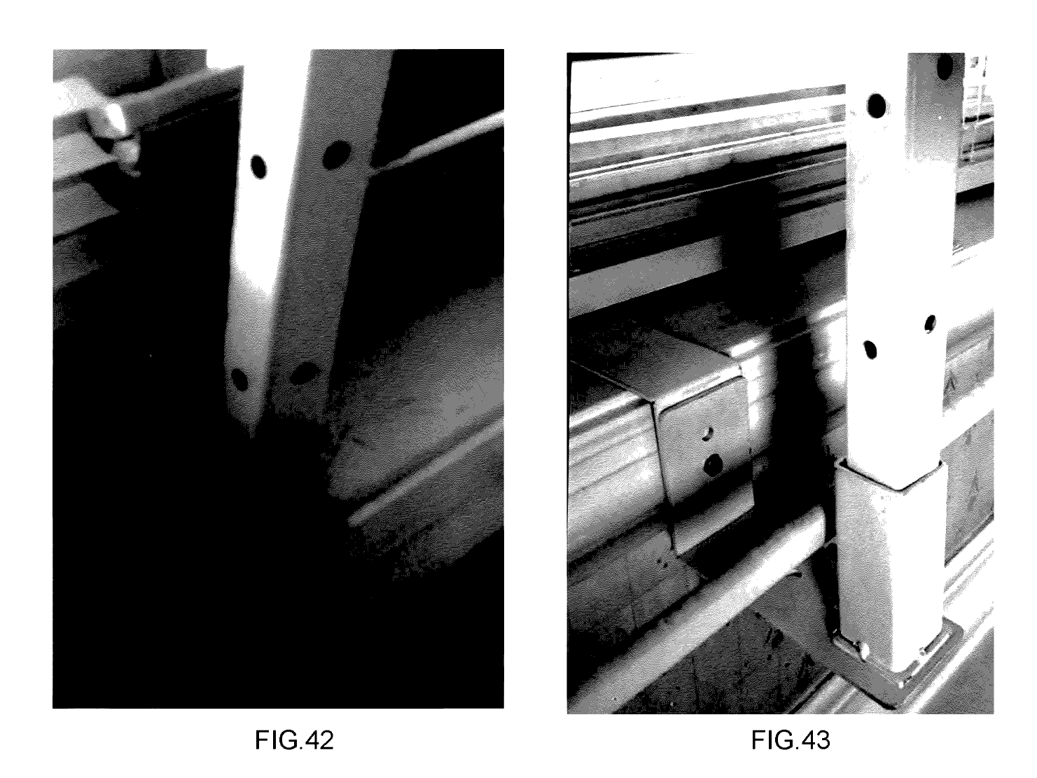

Most of the time, it is very convenient just to use an ordinary bottom attachment and place the bottom attachment on a display surface. However, sometimes, the space where a plant holder to be installed is rather confined or limited as shown in FIG. 42, if only an ordinary bottom attachment is used, the plant holder is on the edge of the windowsill. In a preferred example, two L shaped bars and a double screw receiver as shown in FIG. 37 can be used to attach the lower pole of the plant holder to a upper window frame.

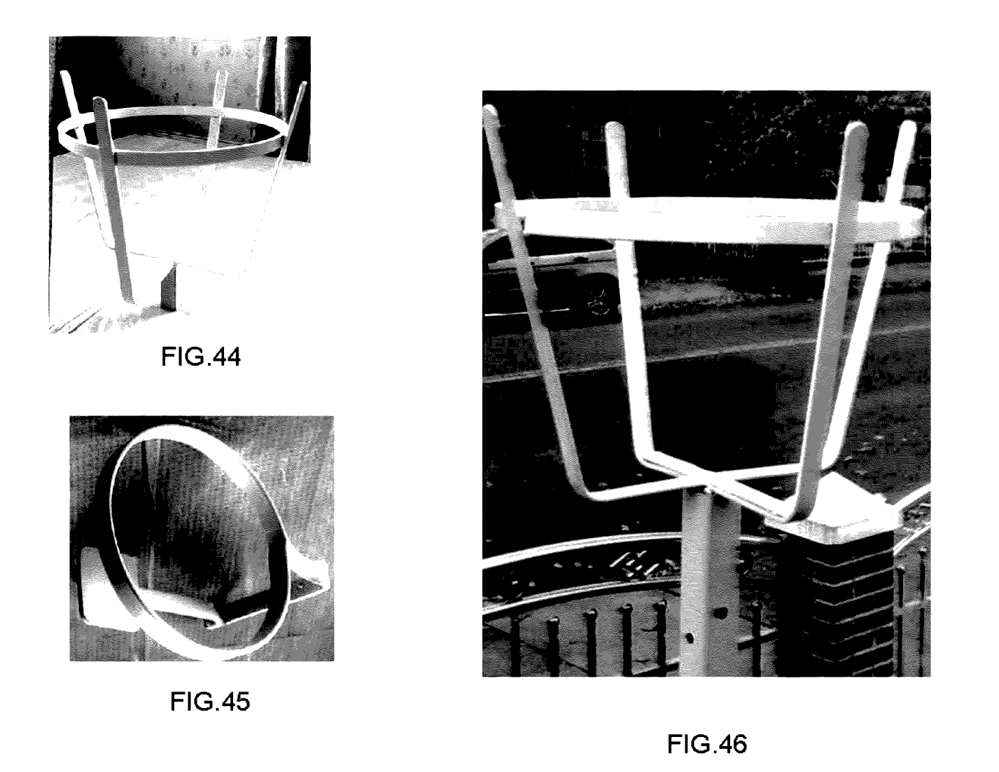

FIGS. 44 and 45 show two examples of pot holding elements. The one illustrated in FIG. 44 is best to be used at the top of the plant holder in accordance with the aspects of the present invention. The other pot holding element, a cup shaped pot holding element, can be used either attached to the side of the upper pole with the addition of a supporting fixture or to be attached to the top. FIG. 46 shows an illustration when the crown shaped pot holding element is placed on the top of the plant holder when the entire plant holder is placed outdoors. The crown shaped pot holding element as shown in FIGS. 44 and 46 are 8.5 inch deep and 9 inch wide. The cup shaped holding element is about 7 inches wide and 4 inches deep, having two holes, which are 3 inches apart. The two holes on a vertical bar of the cup holding element is meant to help the cup holding element to be secured to the upper or lower pole of the plant holder.

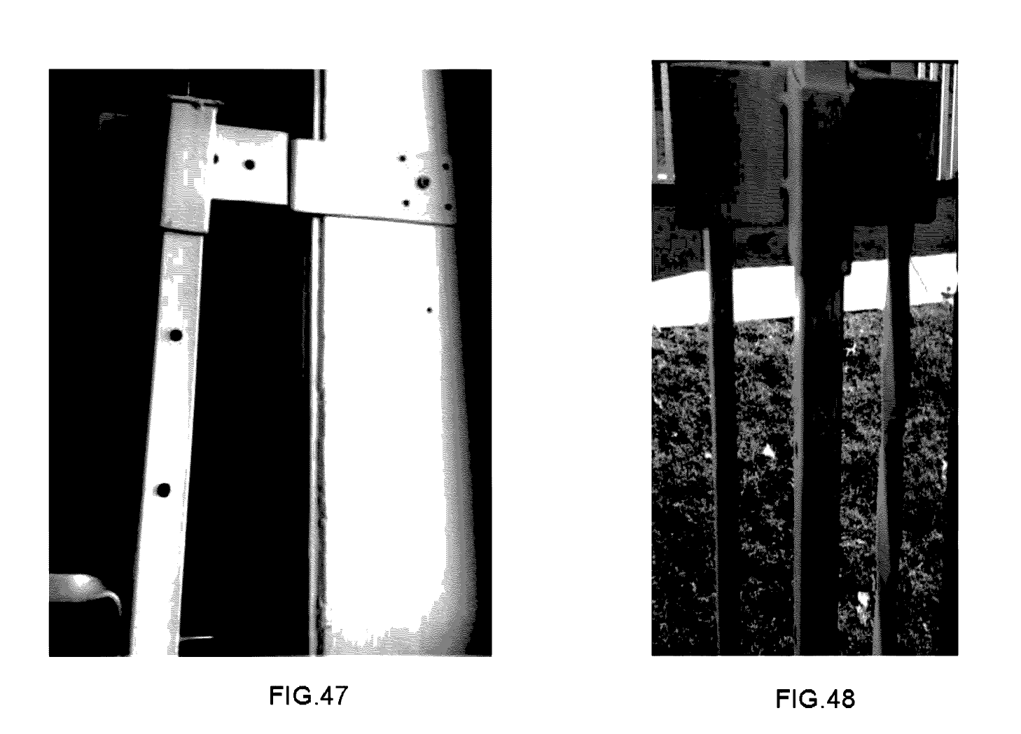

Referring to FIG. 47, when the plant holder is placed indoors, sometimes, the top of the plant holder is not able to fix the crown shaped pot holding element due to space limitations or the upper end of the upper pole of the plant holder needs to be secured in order to prevent unwanted falling of the plant holder. In one example, as shown in FIG. 47, the top of the plant holder is installed on the side of the window frame holding to upper pole straight by means of two L shaped bars and a double crew receiver.

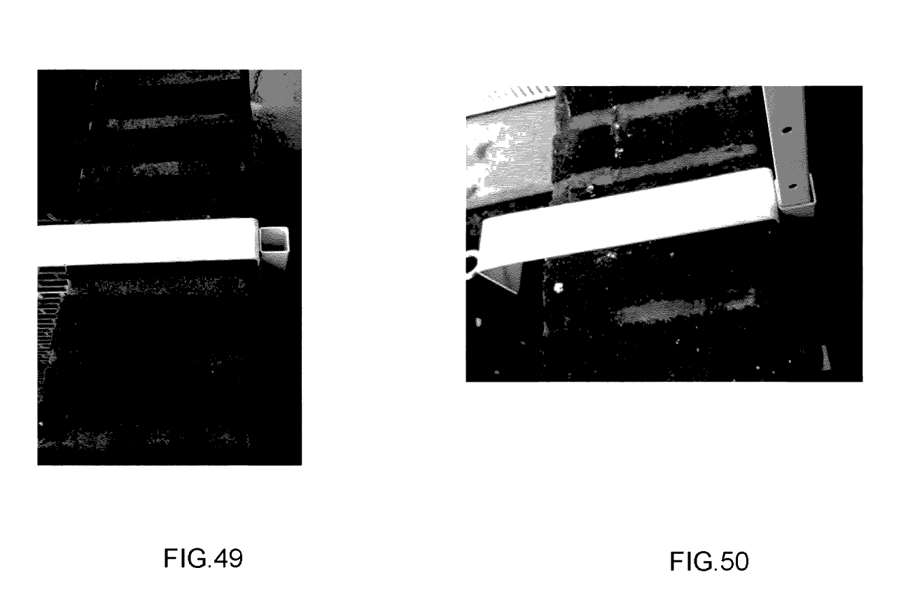

When the plant holder is placed outdoors, the plant holder is designed to adaptable to various places in a garden. In one example, the plant holder is attached to a brick member. A brick stabilizer shown in FIGS. 49 and 50 are used. The brick stabilizer sits on a brick element and holds the upper and lower pole of the plant holder straight. Further, the lower pole of the plant holder can sit on a 3 inch tall and 1.25 inches wide bottom attachment as indicated in FIG. 50.

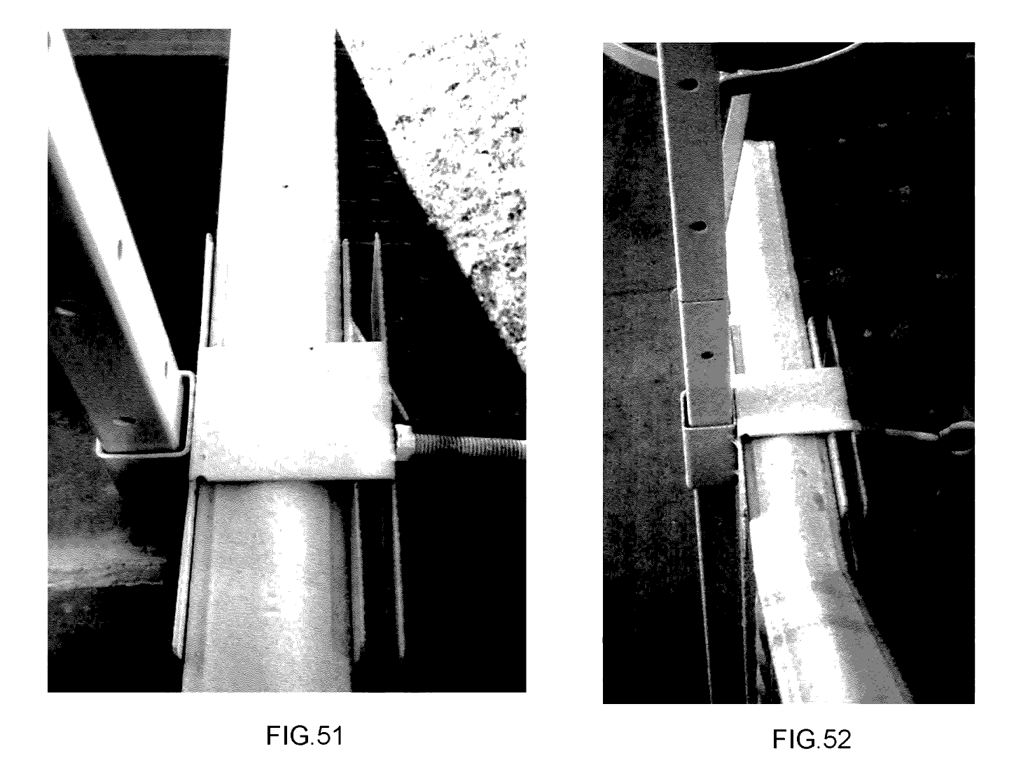

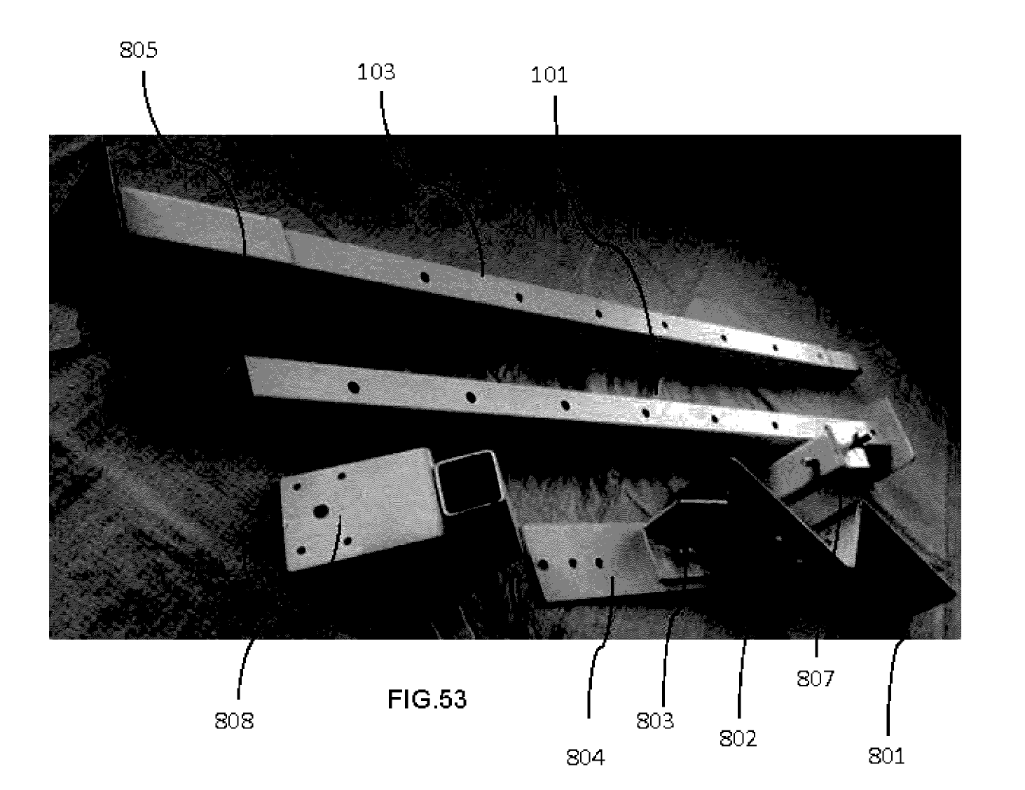

FIGS. 51 and 52 illustrate another embodiments of the present invention. When the plant holder is placed outside and the side of the lower pole can be attached to garden rail through a grill stabilizer bracket as shown. In one example, the grill stabilizer bracket is adjustable and can be placed across a rail about 2 inches wide.

In one embodiment of the present invention, the plant holder is consisting essentially of an upper pole 101, a lower pole 103, a lower frame holding bracket 808, slide over sleeve 805, a first L shaped bar 801, a second L shaped bar 802, a flat bar 804 and a third L shaped bar 803, a double screw receiver 807, and one or more pot holding elements. The lower frame holding bracket is made of the first L shaped bar and a slide through sleeve unit.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not meant to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as coming within the scope of the invention.

1. A plant holder having an adjustable height for a target location, comprising a telescopic pole, having an inner pole and outer pole, wherein the inner pole is sleeved inside of the outer pole, each of the inner and outer pole having regularly arranged openings designed so that the height of the telescopic pole can be adjusted and the openings aligned by adjustment so that an outer pole opening over lies an inner pole opening, the overlying openings can accommodate a supporting device for a plant; and
two fixing bases for securing the telescopic pole to one or more mounting surfaces in the target location; wherein when the plant holder is assembled with two fixing base a plurality of plants weighing up to seven pounds can be supported.

2. The plant holder of claim 1, wherein the telescopic pole is made of plastic or metal.

3. The plant holder of claim 1, wherein the two fixing bases include a top, bottom or side fixing base.

4. The plant holder of claim 1, wherein the openings are of substantially equal sizes.

5. The plant holder of claim 1, wherein the two mounting surfaces are substantially parallel

6. The plant holder of claim 1, wherein the supporting device for a plant comprises a top supporting element and a bottom supporting element.

7. The plant holder of claim 6, wherein the supporting device for a plant further comprises a top gripping element.

8. The plant holder of claim 6, wherein the supporting device for a plant comprises a bottom gripping element.

9. The plant holder of claim 7, wherein the openings are grouped in pairs to accommodate a supporting device having more than one gripping element.
